(19) United States
(12) Patent Application Publication
(10) Pub. No.: US 2025/0323339 A1
(43) Pub. Date: Oct. 16, 2025

(54) ENERGY STORAGE DEVICE

(71) Applicant: TOYOTA JIDOSHA KABUSHIKI KAISHA, Toyota-shi (JP)

(72) Inventors: Shintaro UTSUMI, Susono-shi (JP); Takeru Hara, Toyota-shi (JP); Masataka Ogushi, Nisshin-shi (JP); Yuji Nishi, Nagoya-shi (JP); Naofumi Nomura, Nagakute-shi (JP); Nariaki Miki, Okazaki-shi (JP); Kenta Kimura, Toyota-shi (JP)

(73) Assignee: TOYOTA JIDOSHA KABUSHIKI KAISHA, Toyota-shi (JP)

(21) Appl. No.: 19/082,663

(22) Filed: Mar. 18, 2025

(30) Foreign Application Priority Data
Apr. 10, 2024 (JP) 2024-063168

(51) Int. Cl. H01M 10/613; H01M 10/625; H01M 10/647; H01M 10/6554; H01M 10/6556; H01M 10/6567; H01M 50/24

(52) U.S. Cl. CPC H01M 10/613; H01M 10/625; H01M 10/647; H01M 10/6554; H01M 10/6556; H01M 10/6567; H01M 50/24

(57) ABSTRACT

An energy storage device includes an energy storage module, and a cooler disposed above the energy storage module. The cooler includes a cooler body (first portion) extending along an upper surface (first upper surface) of the energy storage module, and a blocking portion (second portion) provided so as to protrude upward from the cooler body. The blocking portion is provided so as to block the condensation water generated on the upper surface (second upper surface) of the cooler body from flowing toward the outer peripheral edge of the cooler body.

### CROSS-REFERENCE TO RELATED APPLICATION

This application claims priority to Japanese Patent Application No. 2024-063168 filed on Apr. 10, 2024, incorporated herein by reference in its entirety.

### BACKGROUND

### 1. Technical Field

The present disclosure relates to energy storage devices.

### 2. Description of Related Art

Japanese Unexamined Patent Application Publication (Translation of PCT Application) No. 2023-529400 (JP 2023-529400 A) discloses a battery pack including a plurality of unit cells, a tray, a vapor chamber, and a cooling pipe. The unit cells are housed in a housing space of the tray. The vapor chamber covers an upper opening of the housing space of the tray. The cooling pipe is disposed on an outer surface (opposite surface from the housing space) of the vapor chamber.

### SUMMARY

In the battery pack described in JP 2023-529400 A, condensation water may form on the upper surface of the vapor chamber (cooler). In this case, the condensation water may flow on the upper surface and drip from the outer peripheral edge of the vapor chamber.

The present disclosure was made to solve the above issue, and an object thereof is to provide an energy storage device configured to reduce dripping of condensation water formed on an upper surface of a cooler from the cooler.

An energy storage device according to an aspect of the present disclosure includes: an energy storage module; and a cooler disposed above the energy storage module. The cooler includes a first portion extending along a first upper surface of the energy storage module, and a second portion protruding upward from the first portion. The second portion is configured to block condensation water formed on a second upper surface of the first portion from flowing toward an outer peripheral edge of the first portion.

As described above, in the energy storage device according to the above aspect of the present disclosure, the second portion is provided that blocks condensation water formed on the second upper surface of the first portion from flowing toward the outer peripheral edge of the cooler. This can reduce the possibility that the condensation water may flow to the outer peripheral edge of the first portion. This can reduce dripping of the condensation water from the cooler.

The second portion may extend along the outer peripheral edge of the first portion. This configuration can minimize the area of a portion of the second upper surface of the first portion that is located between the second portion and the outer peripheral edge. As a result, this configuration can minimize the amount of condensation water that forms between the second portion and the outer peripheral edge.

The second portion may continuously extend in a surrounding manner along the outer peripheral edge. With this configuration, the second portion does not have a passage that allows communication between inside the second portion and outside the second portion. This can more reliably reduce the possibility that the condensation water formed inside the second portion may flow to the outer peripheral edge.

The energy storage device may further include a case that houses the energy storage module and the cooler. The case may include an upper cover that covers the cooler from above. The second portion may be an elastic member. With this configuration, the load transferred from the upper cover to the second portion can be absorbed by the elastic force of the second portion. This can reduce a damage to the cooler and the energy storage module due to the load from the upper cover.

The energy storage device may further include a thermal insulation material disposed on the second upper surface of the first portion. This configuration can reduce the area of the exposed portion of the second upper surface compared to the case where the thermal insulation material is not disposed on the second upper surface. This can reduce the amount of condensation water that forms on the second upper surface compared to the case where the thermal insulation material is not disposed on the second upper surface. As a result, dripping of the condensation water from the cooler can further be reduced.

The present disclosure can reduce dripping of condensation water formed on the upper surface of the cooler from the cooler.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a vehicle equipped with an energy storage device according to a first embodiment;

FIG. 2 is an exploded perspective view illustrating a configuration of the energy storage device according to the first embodiment;

FIG. 3 is a perspective view showing a configuration of an energy storage cell;

FIG. 4 is a top plan view of an energy storage module and a cooler according to the first embodiment;

FIG. 5 is a cross-sectional view taken along line V-V in FIG. 4;

FIG. 6 is a cross-sectional view of an energy storage device according to a second embodiment;

FIG. 7 is a plan view of an energy storage module and a cooler according to a first modification of the first embodiment as viewed from above;

FIG. 8 is a plan view of an energy storage module and a cooler according to a second modification of the first embodiment when viewed from above; and

FIG. 9 is a cross-sectional view of an energy storage device according to a third modification of the first embodiment.

### DETAILED DESCRIPTION OF EMBODIMENTS

Hereinafter, embodiments of the present disclosure will be described in detail with reference to the drawings. In the drawings, the same or corresponding parts are denoted by the same reference numerals, and the description thereof will not be repeated.

Hereinafter, embodiments and modifications according to the present disclosure will be described with reference to the drawings. In the following description, the same components and components are denoted by the same reference numerals. The same applies to names and functions thereof. Therefore, a detailed description thereof will not be repeated. It should be noted that the embodiments and the modification examples described below may be selectively combined as appropriate.

### First Embodiment

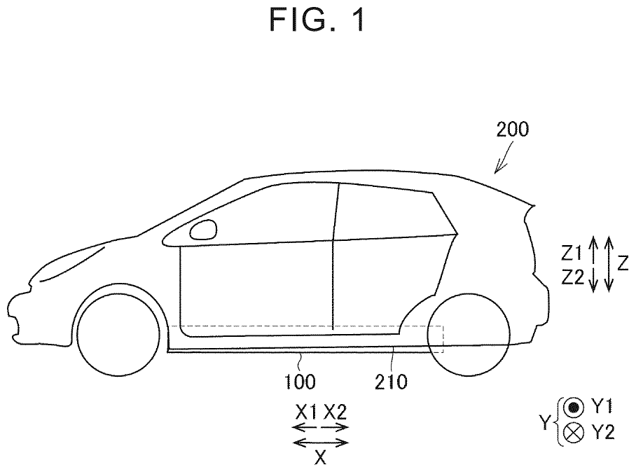

The energy storage device 100 according to the first embodiment will be described with reference to FIGS. 1 to 5. FIG. 1 is a side view schematically showing a vehicle 200 including an energy storage device 100 according to a first embodiment. Note that the X direction, the Y direction, and the Z direction in this specification are directions orthogonal to each other. For example, the X direction and the Y direction are the front-rear direction and the vehicle width direction of the vehicle 200 when the energy storage device 100 is mounted on the vehicle 200, respectively. Further, the Z direction is an up-down (vertical) direction.

Referring to FIG. 1, the energy storage device 100 is, for example, a device for storing electric power for driving the vehicle 200. The energy storage device 100 is disposed on an under body 210 (floor panel) of the vehicle 200. Exemplary vehicles 200 may include hybrid electric vehicle, plug-in hybrid electric vehicle, fuel cell electric vehicle, and battery electric vehicle. Note that the use of the energy storage device 100 is not limited to a vehicle. The energy storage device 100 may be provided in an electric device other than a vehicle (for example, a stationary energy storage device).

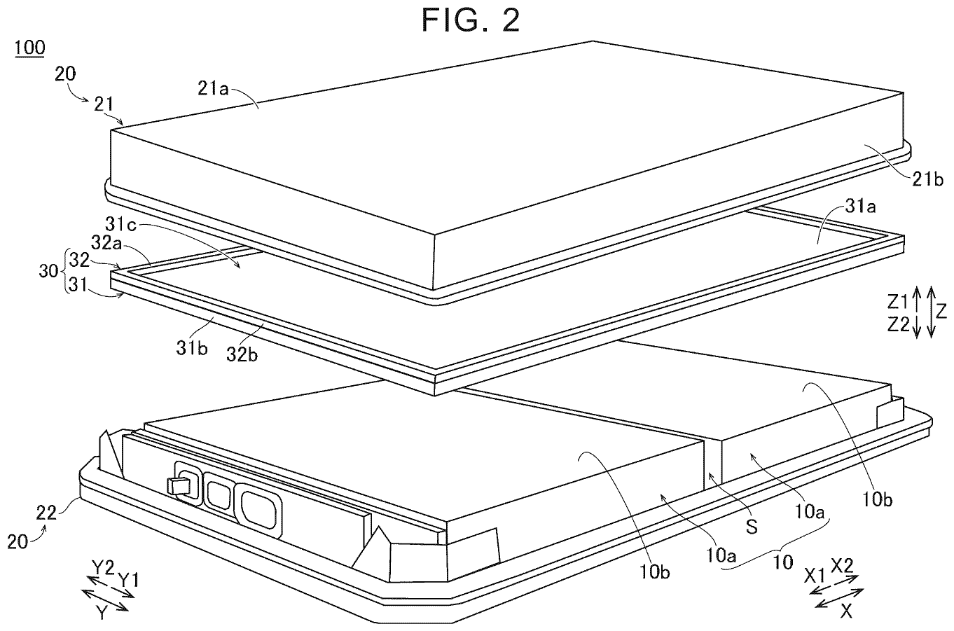

FIG. 2 is an exploded perspective view illustrating a configuration of the energy storage device 100 according to the first embodiment. The energy storage device 100 includes an energy storage module 10, a case 20, and a cooler 30.

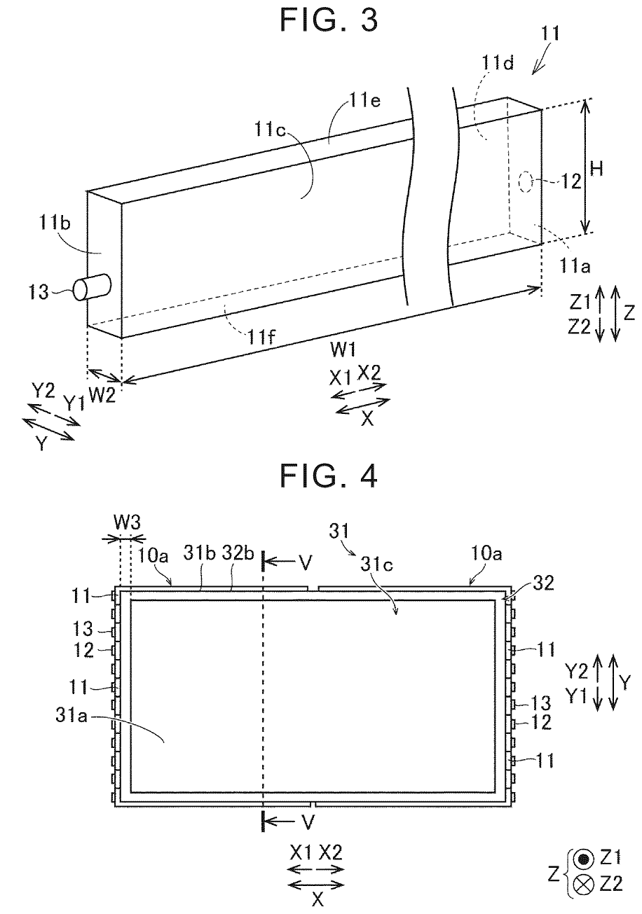

The energy storage module 10 includes two cell units 10a. The cell units 10a include a plurality of energy storage cells 11 (FIG. 3). The two cell units 10a are arranged side by side in the X-direction. A space S is formed between the cell units 10a. The number of the cell units 10a may be 1 or 3 or more.

The case 20 houses the energy storage module 10. The case 20 includes an upper case 21 and a lower case 22. The energy storage module 10 is accommodated in a space formed by assembling the upper case 21 to the lower case 22. The cooler 30 is also housed in the case 20. The upper case 21 is an example of an “upper cover” of the present disclosure.

The upper case 21 has a ceiling portion 21a and a peripheral wall 21b. The ceiling portion 21a is provided at an Z1 end portion of the upper case 21. The ceiling portion 21a extends horizontally. The peripheral wall 21b is provided so as to extend Z2 from the outer peripheral edge of the ceiling portion 21a. The ceiling portion 21a is provided so as to cover the cooler 30 from Z1 side, and the peripheral wall 21b is provided so as to surround the cooler 30 from the side. The peripheral wall 21b is constituted by side walls (not denoted) provided on X1 side, X2 side, Y1 side, and Y2 side with respect to the cooler 30.

The cooler 30 is disposed above (Z1 to) the energy storage module 10. The cooler 30 is disposed across the two cell units 10a. The cooler 30 is provided so as to cover the two cell units 10a and the space S from Z1.

The cooler 30 includes a cooler body 31 and a blocking portion 32. The cooler body 31 extends along the upper surface 10b of the respective cell units 10a. The cooler body 31 is formed in a flat plate shape so as to extend along the upper surface 10b. A cooling liquid flow path (not shown) through which the cooling liquid flows is formed inside the cooler body 31. The cooler body 31 is made of, for example, aluminum. The cooler body 31 and the blocking portion 32 are examples of the “first portion” and the “second portion” of the present disclosure, respectively. Further, the upper surface 10b is an exemplary “first upper surface” of the present disclosure.

The blocking portion 32 is disposed Z1 of the cooler body 31. Specifically, the blocking portion 32 is disposed on the upper surface 31a of the cooler body 31. The blocking portion 32 may be fixed to the upper surface 31a by, for example, an adhesive material, a weld, or the like. Note that the upper surface 31a is an exemplary “second upper surface” of the present disclosure.

The blocking portion 32 is provided so as to protrude Z1 from the cooler body 31. That is, the upper surface 32a, which is the upper end surface of the blocking portion 32, is located Z1 the upper surface 31a, which is the upper end surface of the cooler body 31.

The upper surface 32a of the blocking portion 32 extends in parallel with the upper surface 31a of the cooler body 31. That is, the upper surface 32a is a flat surface extending horizontally (perpendicularly to the Z-direction).

Here, in the conventional energy storage device, the condensation water generated on the upper surface of the cooler may flow through the upper surface of the cooler and be dropped from the outer peripheral edge of the cooler.

Therefore, in the present embodiment, the blocking portion 32 is provided so as to block the condensation water formed on the upper surface 31a of the cooler body 31 from flowing toward the outer peripheral edge 31b of the cooler body 31. Specifically, the blocking portion 32 is disposed so as to divide (isolate) the outer peripheral edge 31b and the inner area 31c of the cooler body 31 provided inside the blocking portion 32. Details will be described later.

FIG. 3 is a perspective view illustrating a configuration of the energy storage cell 11. The energy storage cell 11 has a short side surface 11a, a short side surface 11b, a long side surface 11c, a long side surface 11d, an upper surface 11e, and a lower surface 11f.

The short-side surface 11a and the short-side surface 11b are one end surface and the other end surface of the energy storage cell 11 in the X-direction, respectively. The long side surface 11c and the long side surface 11d are one end surface and the other end surface of the energy storage cell 11 in the Y-direction, respectively.

The upper surface 11e and the lower surface 11f are Z1 end surface and Z2 end surface of the energy storage cell 11, respectively. The upper surface 10b (FIG. 1) of the cell unit 10a is formed by arranging the upper surfaces 11e of the plurality of energy storage cells 11 in the Y-direction.

The energy storage cell 11 is formed to be long in the X direction. Specifically, the width W1 of the energy storage cell 11 in the X direction is larger than the width W2 of the energy storage cell 11 in the Y direction. The width W1 is larger than the height H of the energy storage cell 11 in the Z-direction. The height H is greater than the width W2. Note that the energy storage cell 11 may be formed to be long in the Y direction.

The energy storage cell 11 further includes a positive electrode terminal 12 and a negative electrode terminal 13. The positive electrode terminal 12 is provided on the short side surface 11a. The negative electrode terminal 13 is provided on the short side surface 11b.

FIG. 4 is a plan view of the cooler 30 and the energy storage module 10 viewed from above (Z1). The blocking portion 32 is provided along the outer peripheral edge 31b of the cooler body 31. Specifically, when viewed from Z1, the outer peripheral edge 32b of the blocking portion 32 overlaps with the outer peripheral edge 31b of the cooler body 31.

Therefore, the upper surface 31a of the cooler body 31 is exposed only in the inner area 31c provided inside the blocking portion 32. Thus, it is possible to reduce the possibility of condensation water of the cooler body 31 forming outside the blocking portion 32.

Specifically, the blocking portion 32 continuously extends in a surrounding manner along the outer peripheral edge 31b of the cooler body 31. In other words, the blocking portion 32 is formed in a ring shape and is provided so as to surround the inner area 31c when viewed from Z1 side.

The blocking portion 32 has a width W3 when viewed from the Z1 side. The width W3 is a width in the Y direction of a portion of the blocking portion 32 extending in the X direction, and is a width in the X direction of a portion of the blocking portion 32 extending in the Y direction. The widths W3 of the respective parts of the blocking portion 32 are equal to each other. The width W3 is smaller than, for example, the width W2 (FIG. 3) of the energy storage cell 11 in the Y-direction. Note that the width W3 may be equal to or larger than the width W2.

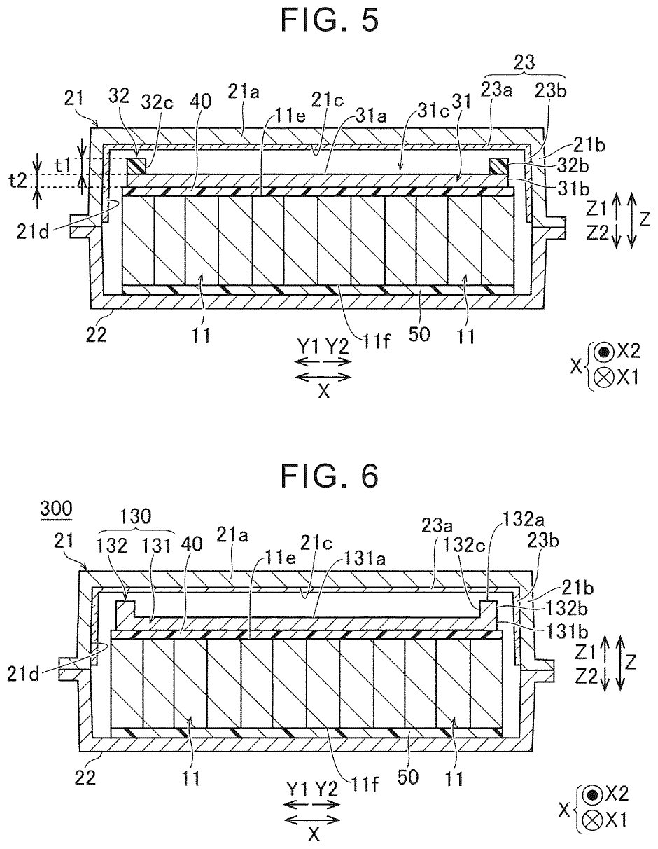

FIG. 5 is a cross-sectional view taken along line V-V in FIG. 4. As illustrated in FIG. 5, the energy storage device 100 further includes a thermally conductive material 40 and an adhesive 50. The thermally conductive material 40 is disposed (coated) on the upper surface 11e of the energy storage cells 11. As a result, the upper surface 10b (FIG. 1) of the cell units 10a are covered with the thermally conductive material 40.

The adhesive 50 is provided between the lower surface 11f of the energy storage cells 11 and the lower case 22. Thus, the energy storage cells 11 are fixed to the lower case 22 by the adhesive 50.

The blocking portion 32 has a thickness t1 in the Z-direction. The cooler body 31 has a thickness t2 in the Z-direction. The thickness t1 is equal to or greater than the thickness t2. As a result, as compared with the case where the thickness t1 is less than the thickness t2, the condensation water generated on the upper surface 31a of the cooler body 31 (the inner area 31c) is suppressed from flowing to the outside of the cooler 30 beyond the blocking portion 32.

The blocking portion 32 is formed of a material (e.g., fibers such as wool, cotton, rayon, and nylon) that generates heat when absorbing moisture. As a result, the condensation water that has been blocked by the blocking portion 32 is absorbed by the blocking portion 32, and is evaporated by the heat generated by the blocking portion 32.

The blocking portion 32 is formed of an elastic member. The blocking portion 32 is formed of a material having a smaller elastic modulus (Young's modulus, etc.) than the case 20 (the upper case 21 and the lower case 22), for example. The blocking portion 32 may be formed of a fiber or the like having hygroscopic heat generating property and having a low elastic modulus as described above. Note that the blocking portion 32 may be formed of rubber, sponge, or the like. Accordingly, the blocking portion 32 also functions as a buffer member for the upper member (for example, the upper case 21 or the like). Therefore, the blocking portion 32 is more useful as a buffer member than when the thickness t1 of the blocking portion 32 is less than the thickness t2 of the cooler body 31.

The blocking portion 32 has an inner surface 32c. The inner surface 32c of the blocking portion 32 extends in the Z-direction. That is, the inner surface 32c is perpendicular to the upper surface 31a of the cooler body 31. As a result, condensation water generated on the upper surface 31a of the cooler body 31 (inner area 31c) can be more reliably blocked by the blocking portion 32 than when the inner surface 32c of the blocking portion 32 is inclined so as to face Z1. In addition, the condensation water is less likely to accumulate below the inner surface 32c as compared with the case where the inner surface 32c of the blocking portion 32 is inclined so as to face Z2.

The case 20 further includes a thermal insulation member 23. The thermal insulation member 23 is formed in a sheet shape. The thermal insulation member 23 includes an upper portion 23a and a side portion 23b. The upper portion 23a is attached to the inner surface 21c of the ceiling portion 21a of the upper case 21. The side portion 23b is attached to the inner peripheral surface 21d of the peripheral wall 21b of the upper case 21. Each of the inner surface 21c and the inner peripheral surface 21d of the upper case 21 faces the inside of the case 20. Providing the thermal insulation member 23 can reduce the possibility of the upper case 21 being cooled by the cooler 30. As a result, it is possible to reduce formation of condensation water on the outer surface of the upper case 21.

The upper portion 23a of the thermal insulation member 23 is provided so as to cover the cooler 30 from Z1 side. The side portion 23b of the thermal insulation member 23 is provided so as to surround the cooler 30 from the side. The upper portion 23a is integrally formed with the side portion 23b. Note that the upper portion 23a may be provided separately (separated) from the side portion 23b.

The blocking portion 32 is separated from the thermal insulation member 23. Note that the blocking portion 32 and the thermal insulation member 23 (for example, the upper portion 23a) may be in contact with each other.

As described above, in the first embodiment, the blocking portion 32 is provided so as to block the condensation water generated on the upper surface 31a of the cooler body 31 from flowing toward the outer peripheral edge 31b of the cooler body 31. As a result, it is possible to prevent the condensation water from flowing to the outer peripheral edge 31b by the blocking portion 32. As a consequence, it is possible to reduce dripping of condensation water from the outer peripheral edge 31b. As a result, water droplets are less likely to get on electronic components etc. below the cooler 30.

In the first embodiment, the blocking portion 32 is provided along the outer peripheral edge 31b of the cooler body 31. Accordingly, the area of the part of the upper surface 31a of the cooler body 31 provided between the blocking portion 32 and the outer peripheral edge 31b can be made substantially zero. As a result, the amount of condensation water generated outside the blocking portion 32 can be minimized. In addition, since a portion of the upper surface 31a in the vicinity of the outer peripheral edge 31b is covered by the blocking portion 32, it is possible to suppress the occurrence of condensation water in the portion in the vicinity of the outer peripheral edge 31b.

### Second Embodiment

A second embodiment of the present disclosure will be described with reference to FIG. 6. In the second embodiment, unlike the first embodiment in which the cooler body 31 and the blocking portion 32 are provided separately, the cooler body 131 and the blocking portion 132 are integrally formed. The same components as those of the first embodiment are denoted by the same reference numerals as those of the first embodiment, and the repetitive description thereof will not be given.

The energy storage device 300 of the second embodiment is different from the energy storage device 100 of the first embodiment in that a cooler 130 is provided instead of the cooler 30 (FIG. 2).

The cooler 130 includes a cooler body 131 and a blocking portion 132. The shape (outer diameter), size, arrangement position, and the like of the cooler body 131 are the same as those of the cooler body 31 (FIG. 2) of the first embodiment. The shape (outer diameter), size, arrangement position, and the like of the blocking portion 132 are the same as those of the blocking portion 32 (FIG. 2) of the first embodiment. The cooler body 131 and the blocking portion 132 are examples of the “first portion” and the “second portion” of the present disclosure, respectively.

In the second embodiment, the cooler body 131 is integrally formed with the blocking portion 132. For example, the blocking portion 132 may be formed by bending the outer peripheral edge of the metallic plate constituting the cooler 130 toward Z1. Note that the blocking portion 132 does not have to have a flow path through which the cooling liquid flows.

The cooler body 131 has an upper surface 131a and an outer peripheral edge 131b. The blocking portion 132 has an upper surface 132a, an outer peripheral edge 132b, and an inner surface 132c. The upper surface 131a of the cooler body 131, the inner surface 132c of the blocking portion 132, and the upper surface 132a of the blocking portion 132 are continuously formed. Note that the upper surface 131a is an exemplary “second upper surface” of the present disclosure.

In the second embodiment, the buffer member, the moisture absorbing member, and the like may be disposed on the upper surface 132a of the blocking portion 132. In addition, a buffer member may be attached to the inner surface 21c, the inner peripheral surface 21d, and the like of the upper case 21.

Note that the other configurations are the same as those of the first embodiment, and thus the description thereof will not be repeated.

As described above, in the second embodiment, the blocking portion 132 is integrally formed with the cooler body 131. As a result, the configuration of the cooler 130 can be simplified and the number of components in the cooler 130 (the energy storage device 300) can be reduced as compared with a case where the cooler body 131 and the blocking portion 132 are separate bodies.

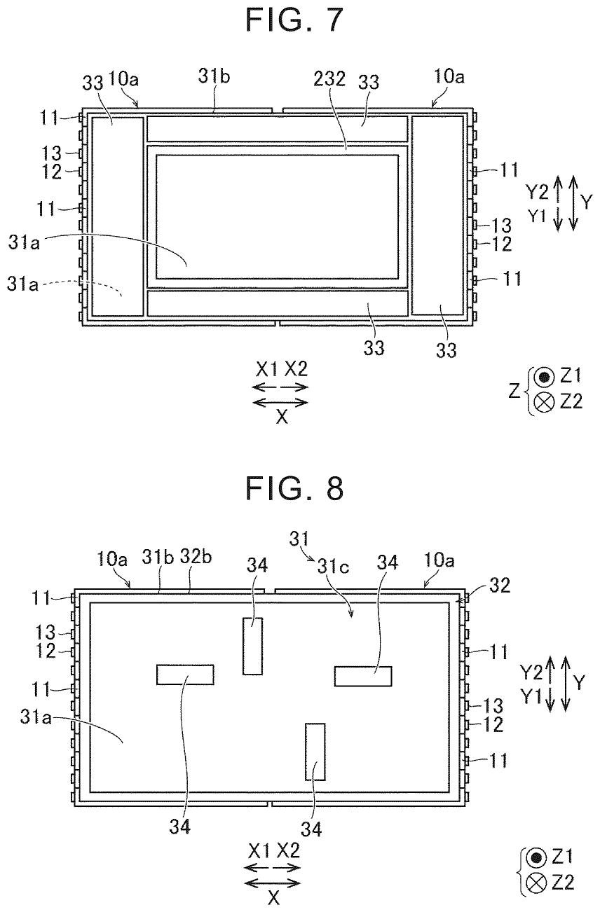

In the first embodiment, the blocking portion 32 is provided along the outer peripheral edge 31b of the cooler body 31, but the present disclosure is not limited thereto. As illustrated in FIG. 7, the blocking portion 232 may be spaced apart from the outer peripheral edge 31b. Here, the thermal insulation material 33 may be disposed on the upper surface 31a of the area between the blocking portion 232 and the outer peripheral edge 31b. Note that the blocking portion 232 is an example of the “second portion” of the present disclosure.

As shown in FIG. 7, a plurality of thermal insulation materials 33 may be disposed outside the blocking portion 232. In addition, a single annular thermal insulation material may be disposed so as to surround the blocking portion 232. As shown in FIG. 7, a part of the upper surface 31a in the area outside the blocking portion 232 may be covered with the thermal insulation material 33. In addition, the entire surface of the upper surface 31a in the outer area of the blocking portion 232 may be covered with a thermal insulation material.

Note that the arrangement position of the thermal insulation material is not limited to the example shown in FIG. 7. For example, the thermal insulation material may be disposed inside the blocking portion 32 (the inner area 31c, FIG. 2).

Further, as shown in FIG. 8, in addition to the blocking portion 32, the blocking portion 34 may be disposed in the inner area 31c. In the example illustrated in FIG. 8, a plurality of (four in FIG. 8) blocking portions 34 are provided, and extend linearly in a predetermined direction (X direction or Y direction). Note that the blocking portion 34 may extend in an oblique direction so as to intersect each of the X direction and the Y direction. In addition, the bent blocking portion may be provided in the inner area 31c. Note that the modification illustrated in FIGS. 7 and 8 may also be applied to the second embodiment.

In the first embodiment, the blocking portion 32 continuously extends in a surrounding manner along the outer peripheral edge 31b. The plurality of blocking portions may be arranged in a surrounding manner along the outer peripheral edge 31b. Note that this modification may also be applied to the second embodiment.

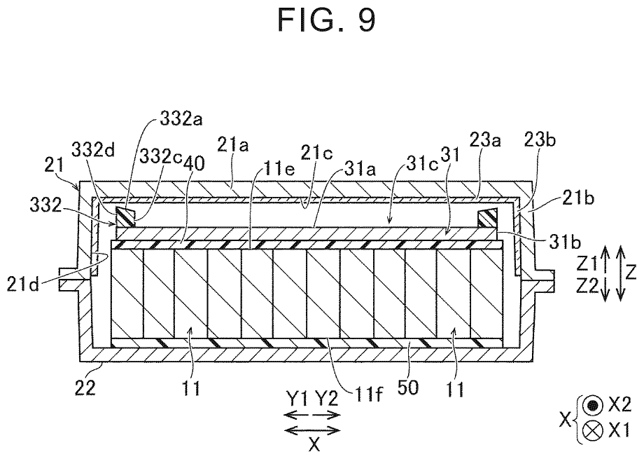

In the first embodiment, the upper surface 32a of the blocking portion 32 extends horizontally, but the present disclosure is not limited thereto. For example, the upper surface of the blocking portion may be inclined with respect to the horizontal direction. Specifically, as shown in FIG. 9, the upper surface 332a of the blocking portion 332 is inclined such that the upper end of the outer surface 332d of the blocking portion 332 is located Z1 of the upper end of the inner surface 332c of the blocking portion 332. As a result, the condensation water that has passed over the inner surface 332c can be returned to the inner area 31c by the upper surface 332a. Note that a step portion or the like may be provided instead of an inclined surface such as an upper surface 332a. Further, a concave portion (groove portion) or the like may be formed on the upper surface of the blocking portion. Note that the blocking portion 332 is an example of the “second portion” of the present disclosure. Further, these modification examples may also be applied to the second embodiment.

In the first embodiment, an example in which the blocking portion 32 is formed of a hygroscopic heat generating material has been described, but the present disclosure is not limited thereto. The blocking portion may not have hygroscopicity and exothermicity. In addition, the blocking portion may have hygroscopicity but not heat generation.

The embodiment disclosed this time should be considered to be illustrative in all respects and not restrictive. The scope of the present disclosure is indicated by the claims rather than the description of the embodiment described above, and it is intended that all changes within the meaning and scope equivalent to the claims are included.

What is claimed is:

1. An energy storage device comprising:
an energy storage module; and
a cooler disposed above the energy storage module, wherein:
the cooler includes
a first portion extending along a first upper surface of the energy storage module, and
a second portion protruding upward from the first portion; and
the second portion is configured to block condensation water formed on a second upper surface of the first portion from flowing toward an outer peripheral edge of the first portion.

2. The energy storage device according to claim 1, wherein the second portion extends along the outer peripheral edge of the first portion.

3. The energy storage device according to claim 2, wherein the second portion continuously extends in a surrounding manner along the outer peripheral edge.

4. The energy storage device according to claim 1, further comprising a case that houses the energy storage module and the cooler, wherein:
the case includes an upper cover that covers the cooler from above; and
the second portion is an elastic member.

5. The energy storage device according to claim 1, further comprising a thermal insulation material disposed on the second upper surface of the first portion.
